(19) United States
(12) Patent Application Publication
(10) Pub. No.: US 2018/0320834 A1
(43) Pub. Date: Nov. 8, 2018

(54) INFLATABLE LIGHT

(71) Applicant: Evergreen Enterprises of Virginia, LLC, Richmond, VA (US)

(72) Inventors: Paul D. MAGUIRE, Goochland, VA (US); Ting XU, Richmond, VA (US)

(21) Appl. No.: 15/586,440

(22) Filed: May 4, 2017

(51) Int. Cl. F21L 4/08; F21V 7/00; F21V 31/00; F21V 21/40; F21V 23/04

(52) U.S. Cl. CPC F21L 4/08; F21V 7/00; F21Y 2115/10; F21V 21/406; F21V 23/0414; F21V 31/00

(57) ABSTRACT

An inflatable lighting device having a rechargeable, solar powered, and inflatable light. The inflatable lighting device includes an inflatable framework that has inflatable support volumes and a non-inflatable portion, a light assembly in a water proof housing, inlet/outlet architecture to inflate and/or deflate the inflatable support volumes, and an interchangeable decorative sleeve to enclose the inflatable framework.

### TECHNICAL FIELD

Embodiments relate to inflatable lighting devices, more particularly, to a rechargeable solar powered inflatable light that could be hung from a hook, placed on a table, or float in a pool. Embodiments also relate to a rechargeable solar powered inflatable light with a dosed first end and an open second end comprising an inflatable framework that further comprises inflatable support volumes and non-inflatable portion, light assembly in a water proof housing, a handle, interchangeable decorative sleeve, and inlet/outlet architecture to inflate and/or deflate the inflatable support volumes.

### BACKGROUND

Conventional designs provide for inflatable and/or erectable solar powered lamps in which light shines into a closed housing, and are to only allow the dispersion of light which is internally reflected and refracted within the enclosed volume.

### SUMMARY

Embodiments differ from conventional designs in providing for an inflatable light with a dosed first end and an open second end comprising an inflatable framework that further comprises inflatable support volumes and non-inflatable portion; light assembly in a water proof housing; a handle; interchangeable decorative sleeve; and inlet/outlet architecture to inflate and/or deflate the inflatable support volumes.

Embodiments offers the following advantages over conventional designs.

First, embodiments provide for brighter illumination. The inflatable solar light assembly of conventional designs discloses dosed housing. While dosed housing of conventional designs traps light and illuminates primarily the enclosed space, the open second end design of embodiments allows light to be emitted straight: through the inner space of the inflatable framework. In this way, trapping of light or loss of light due to reflection and refraction is avoided. Particularly, the surroundings are illuminated rather than the device itself.

Second, embodiments offer the flexibility to create a variety of three-dimensional shapes. The designs of inflatable solar light assembly of conventional designs are configured to specific shapes, whereas in embodiments, the inflatable support volumes of the inflatable framework could be inflated with one or more of air, water, any other fluid, or filled with a gel or solid material creating an inflated pattern of support volumes, thereby creating different perimeter shapes and designs for the inflatable light.

Third, embodiments offer several aesthetic advantages. The inflatable solar light assembly of conventional designs are inexpensive, lightweight and portable, however, lack aesthetic appeal. The inflatable framework of embodiments has inflatable support volumes and non-inflatable portion that enables flexibility in having different colour combinations for inflatable support volumes and non-inflatable portion. Further, inflatable support volumes could be filled with decorative elements or coloured fluid to create different visual effect. Moreover, an interchangeable and removeable decorative sleeve that encloses the inflatable framework of the inflatable light is made up of a fabric or a flexible polymer layer with variety of decorative designs.

Embodiments are directed towards an inflatable light with a closed first end and an open second end. The inflatable light comprises an inflatable framework; a power source; a light assembly; an interchangeable decorative sleeve; and inlet/outlet architecture to inflate and/or deflate the inflatable support volumes. The inflatable framework of the inflatable light comprises inflatable support volumes that are filled with one or more of gas, liquid, gel or solid; and may include a non-inflatable portion. The power source is one of solar power; electric power; or battery power. The light assembly comprises printed circuit board (PCB); at least one light emitting diode (LED) arranged on the inner face of the PCB; a reflector with apertures placed over LEDs; and a water proof bezel that encloses all the components of the light assembly. The light assembly is mounted on one end of the inflatable framework that forms the closed first end of the inflatable light, while the other end of the inflatable framework forms the open second end of the inflatable light. The inflatable framework of the inflatable light may be enclosed by an interchangeable decorative sleeve. The interchangeable decorative sleeve is elastically gathered outside of the inflatable framework at both closed first end and open second end. The interchangeable decorative sleeve is made up of a fabric or a flexible polymer layer with variety of decorative designs.

### DRAWINGS

The summary of embodiments, as well as the detailed description is better understood when read in conjunction with the accompanying drawings that illustrate one or more possible embodiments of embodiments, in which:

FIG. 1 is a perspective view of the inflatable light, in accordance with embodiments.

FIG. 2 is an exploded view of the inflatable light of FIG. 1 having rechargeable solar power.

FIG. 3A is a perspective view of an outer face of the printed circuit board of the inflatable light of FIG. 1.

FIG. 3B is a perspective view of an inner face of the printed circuit board of the inflatable light of FIG. 1.

FIG. 3C is a perspective view of a rechargeable battery of the inflatable light of FIG. 1.

FIG. 3D is a perspective view of a reflector of the inflatable light of FIG. 1.

FIG. 3E is a perspective view of a water proof bezel of the inflatable light of FIG. 1.

FIG. 3F is a perspective view of a handle of the inflatable light of FIG. 1.

FIG. 3G is a side view of an input/output source embodied as a valve of the inflatable light of FIG. 1.

FIG. 4A is a perspective view of an inflatable light with a spherical inflated pattern, in accordance with embodiments.

FIG. 4B is a perspective view of an inflatable light with a heart cube inflated pattern, in accordance with embodiments.

FIG. 4C is a perspective view of an inflatable light with stacked rings inflated pattern, in accordance with embodiments.

FIG. 5A is a perspective view of an inflatable light with an interchangeable decorative sleeve, in accordance with embodiments.

FIG. 5B is a perspective view of the inflatable light of FIG. 5A, with the interchangeable decorative sleeve enclosing the inflatable framework with stacked rings inflated pattern.

FIG. 5C is a perspective view of an inner layer of the interchangeable decorative sleeve of the inflatable light of FIG. 5A.

FIG. 6 is a block diagram of the inflatable light, in accordance with embodiments.

### DESCRIPTION

An embodiment discloses an inflatable light with a closed first end and an open second end comprising an inflatable framework with inflatable support volumes and non-inflatable portion; a power source; light assembly; a handle; interchangeable decorative sleeve; and inlet/outlet architecture to inflate and/or deflate the inflatable support volumes. The inflatable framework of inflatable light is made up of flexible polymeric material that is either transparent, translucent or opaque. The inflatable framework of inflatable light further comprises inflatable support volumes and non-inflatable portion. The inflatable support volumes are filled with one or more of gas, liquid, gel, solid, and any combination thereof. The inflatable light forms a variety of three-dimensional shapes when inflatable support volumes of inflatable framework is filled with one or more of gas, liquid, gel, solid, and any combination thereof. The power source of inflatable light is one of solar power; electric power; or battery power. The light assembly of inflatable light comprises a printed circuit board (PCB); a reflector; at least one light emitting diode (LED); and a water proof bezel. The light assembly is mounted on one end of the inflatable framework to form a closed first end of the inflatable light and the other end of inflatable framework forms an open second end of the inflatable light. The inflatable light has inlet/outlet architecture, such as, for example, a valve, that is to inflate and/or deflate inflatable support volumes of inflatable framework. A handle is attached to the closed first end of inflatable light.

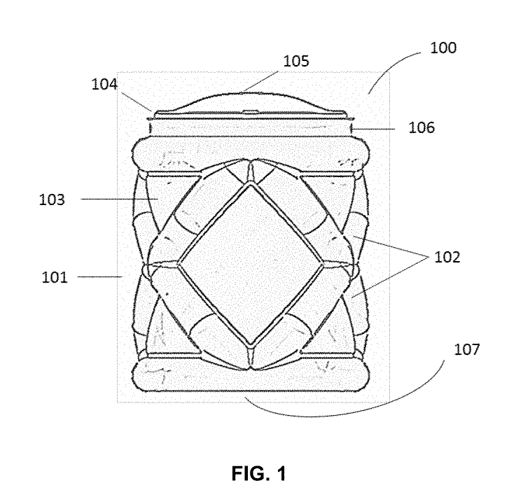

FIG. 1 illustrates the perspective view of the inflatable light 100 with a closed first end 106 and an open second end 107 comprising an inflatable framework 101 with inflatable support volumes 102 on the outer surface of the inflatable framework 101, non-inflatable portion(s) 103; light assembly 104; and handle 105. While the inflatable light 100 is illustrated having non-inflatable portion(s) 103, embodiments are not limited to such a configuration, and thus, may include only inflatable support volumes 102.

An embodiment includes a rechargeable solar powered inflatable light in which power source is a solar power.

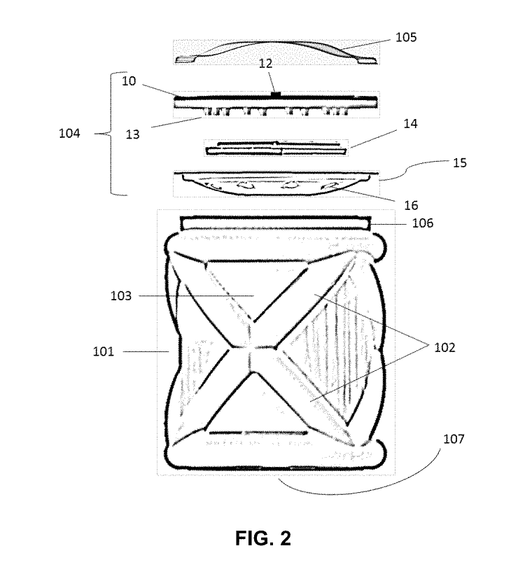

FIG. 2 illustrates an exploded view of the rechargeable solar powered inflatable light of embodiments, in which the rechargeable solar powered light assembly 104 shown in FIG. 1 further comprises a printed circuit board (PCB) 10, solar panel 11, one or many light emitting diodes (LEDs) 13, a rechargeable battery 14, and a reflector 15 having apertures 16. The rechargeable solar powered light assembly 104 comprises a solar panel 11 arranged on the outer face of the PCB 10, LEDs 13 arranged on the inner face of the PCB 10, a rechargeable battery 14 arranged at the center of inner face of the PCB 10, and a reflector 15 with apertures 16 aligned over the LEDs 13.

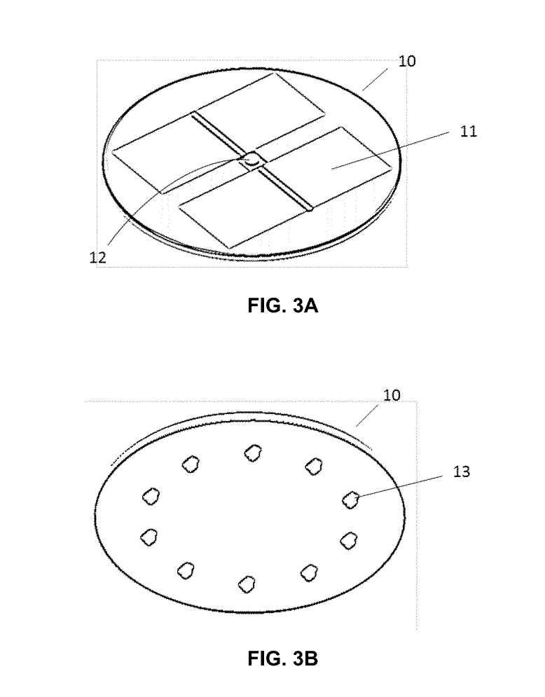

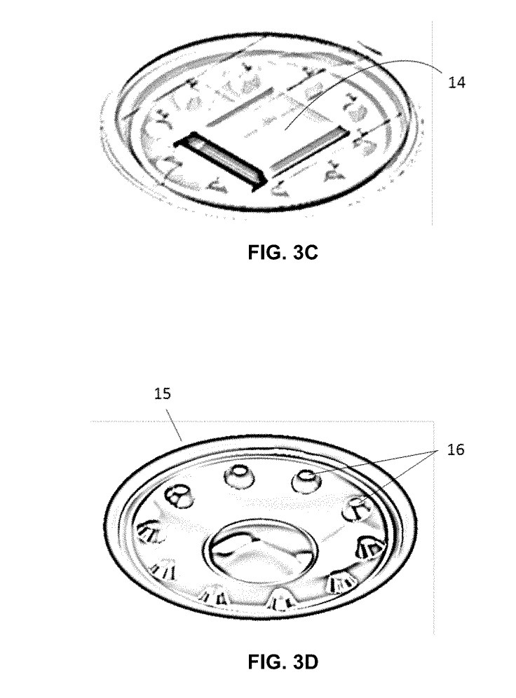

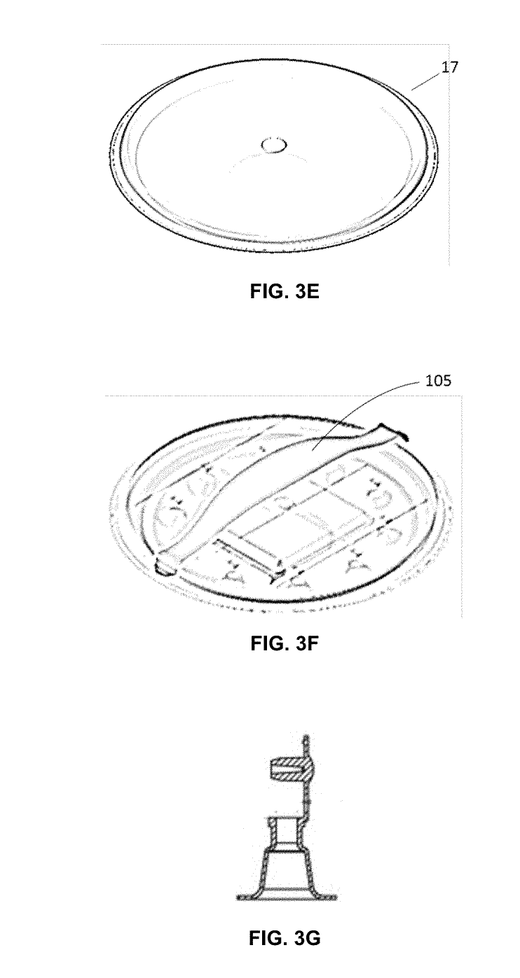

FIGS. 3A through 3E refer to individual components of the solar light assembly 104.

FIG. 3A shows the outer face of the printed circuit board (PCB) 10 that includes solar panel 11 integrated with the PCB 10, a power switch 12 located at the centre of the outer face of PCB 10. The power switch 12 is used to control an operating mode of the plurality of LED lights 13.

FIG. 3B shows the inner face of the printed circuit board 10 that includes at least one LED light or a planar array of LEDs 13 arranged along the circumference.

FIG. 3C shows a rechargeable battery 14 placed at the center of the inner face of the printed circuit board to power LEDs 13.

FIG. 3D shows a reflector 15 that has a reflective surface and apertures 16 that are aligned over the LEDs 13.

As shown in FIG. 3E, all the components of rechargeable solar powered light assembly 104 are enclosed within the water proof bezel 17. The water proof bezel 17 is made up of a material that enables water proof sealing of all components of the rechargeable solar powered light assembly 104.

FIG. 3F shows a handle 105 made out of flexible plastic material that is attached to the closed first end of the rechargeable solar powered inflatable light 100. The handle 105 enables the rechargeable solar powered inflatable light 100 to be attached to a wall or hung from a ceiling, or to be carried from one place to another easily.

FIG. 3G shows an I/O architecture embodied as a valve to inflate and/or deflate the inflatable support volumes.

In FIG. 2, the inflatable framework 101 is collapsible and is made up of a two-layered flexible plastic material. In some embodiments, the framework material is made up of poly (vinyl chloride) (PVC) or thermoplastic polyurethane (TPU) or other similar material.

The inflatable framework 101 of the rechargeable solar powered inflatable light 100 of embodiments promotes ability to create a variety of three-dimensional shapes.

Also, the inflatable framework 101 of the rechargeable solar powered inflatable light 100 of embodiments has an open second end 107 that allows the light to pass straight through the inner space of the inflatable framework 101 eliminating light loss due to reflection and refraction or from trapping of light within the housing.

In some embodiments, the inflatable support volumes 102 of embodiments may be inflated with one or more of air, water, any other fluid or filled with gel or solid material. The inflatable support volumes 102 may be inflated with one or more of air, or any other gas via inlet/outlet architecture. Such inlet/outlet architecture may be embodied, for example, as a valve. Such a valve may be embodied, for example, as a mouth valve (similar to a valve used in a beach ball), or a valve that is operatively connected to a fluid, gel, etc. source pump (not shown). The inflatable support volumes 102 may also be filled with water or other fluids using a syringe-like filling accessory (not shown).

The solar panel 11 used in embodiments, to power the LED lights 13 may be selected from those known in the art.

In an embodiment, the inflatable light 100 when inverted, can be completely filled or partially filled with colored or color-less water or any other fluids and/or gels. In addition to creating a unique visual effect, adding a fluid adds weight to the product, preventing it from being blown out of location by light-to-moderate wind. In a swimming pool, filling the vessel with water would work to shine light within the water of the pool, instead of simply floating on the surface of water, again creating a different and pleasing visual effect.

In an embodiment, the inflatable framework 101 allows for additional decorative elements to be contained between layers of flexible material. Decorative objects or materials may be placed inside the inflated support volumes 102. For example, glitter powder or other decorative material may be placed inside the inflatable support volumes 102 to create a unique aesthetic effect. Decorative materials include string lights, fiber optic lights, electroluminescent wire, ribbon, or other materials or objects.

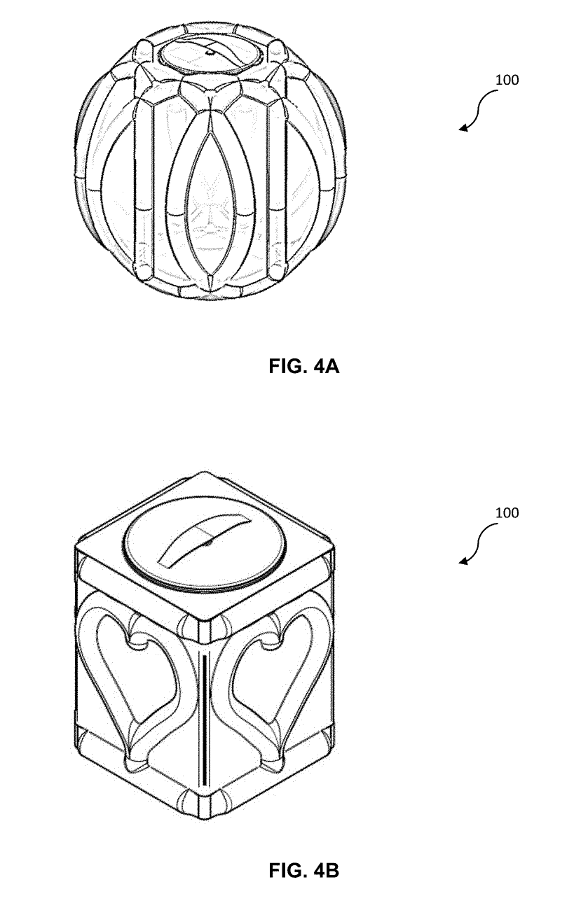

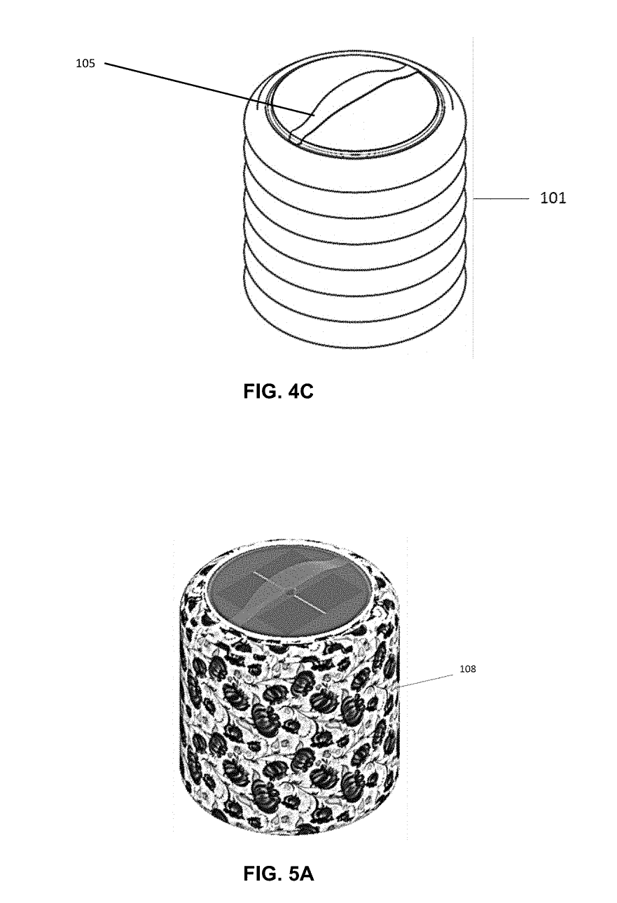

In accordance with embodiments, the inflatable framework 101 forms a variety of three-dimensional shapes, for example, a spherical shaped inflated pattern as illustrated in FIG. 4A, a heart cube inflated pattern as illustrated in FIG. 4B, or a stacked rings inflated pattern as illustrated in FIG. 4C.

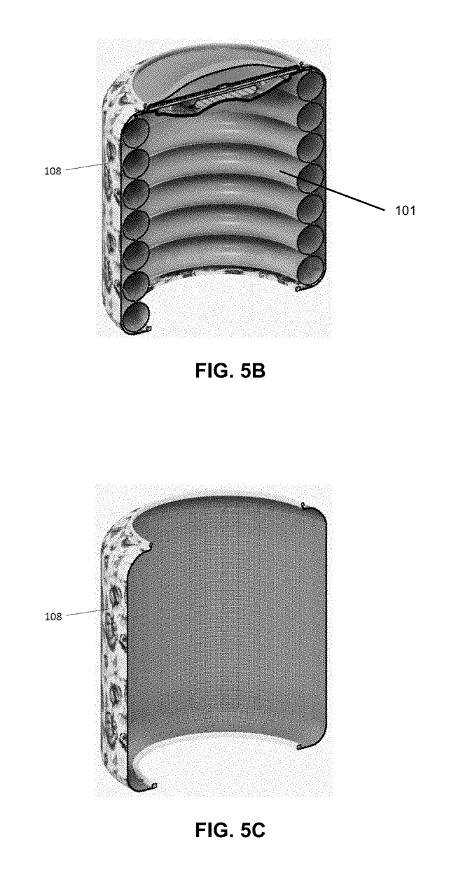

In accordance with embodiments, the inflatable framework 101 is elastically enclosed by an interchangeable decorative sleeve 108 to create an aesthetic effect of illuminated light. For example, FIGS. 5A and 5B illustrate the perspective view of inflatable light with an interchangeable decorative sleeve 108 that encloses the inflatable framework 101 with a stacked rings inflated pattern as shown in FIG. 4C. The inner layer of the interchangeable decorative sleeve 108 is shown in FIG. 5C. The interchangeable decorative sleeve 108 is made up of a fabric or a flexible polymer layer with variety of decorative designs.

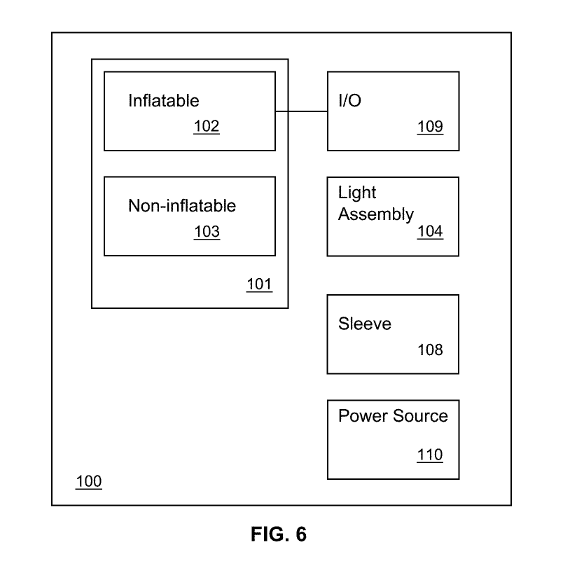

As illustrated in FIG. 6, the inflatable light 100 includes inflatable framework 101 having inflatable support volumes 102 and non-inflatable portion (s) 103, a power source 110, a light assembly 104, an interchangeable decorative sleeve 108, and inlet/outlet architecture 109 to inflate and/or deflate the inflatable support volumes.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### REFERENCE NUMERALS

The following numbering is used throughout drawing figures and detailed description to illustrate embodiments:

100 Inflatable light

101 Inflatable framework

102 Inflatable support volumes

103 Non-inflatable portion

104 Light assembly

105 Handle

106 Closed first end

107 Open second end

108 Interchangeable decorative sleeve

109 Inlet/outlet architecture

110 Power source

10 Printed circuit board

11 Solar panel

12 Power switch

13 Light emitting diode

14 Rechargeable battery

15 Reflector

16 Apertures

17 Water proof Bezel

What is claimed is:

1. An inflatable light device, comprising:
an inflatable framework having a closed first end and an open second end;
a power source;
a light assembly; and
inlet/outlet architecture operatively connected to the inflatable framework to inflate and/or deflate the inflatable framework.

2. The inflatable light device of claim 1, wherein the inflatable framework is composed of a flexible polymeric material that is transparent, translucent or opaque.

3. The inflatable light device of claim 1, wherein the inflatable framework comprises inflatable support volumes and a non-inflatable portion.

4. The inflatable light device of claim 3, wherein the inflatable support volumes are fillable with at least one of gas, liquid, gel, or solid material.

5. The inflatable light device of claim 3, wherein the inlet/outlet architecture is to inflate and/or deflate the inflatable support volumes.

6. The inflatable light device of claim 1, wherein the power source comprises a solar power source. electric power; or battery power.

7. The inflatable light device of claim 1, wherein the power source comprises an electric power source.

8. The inflatable light device of claim 1, wherein the light assembly comprises a printed circuit board, a reflector, at least one light emitting diode, and a water proof bezel.

9. The inflatable light device of claim 1, wherein the light assembly is configured for mounting on a first end of the inflatable framework to form the closed first end.

10. The inflatable light device of claim 9, wherein the light assembly is configured for mounting on a second end of the inflatable framework to form the open second end.

11. The inflatable light device of claim 1, further comprising a handle configured for attachment to the closed first end.

12. The inflatable light device of claim 1, further comprising an interchangeable decorative sleeve to cover the inflatable framework.

13. The inflatable light device of claim 12, wherein the interchangeable decorative sleeve is elastically connected to an outside surface of the inflatable framework at both the closed first end and the open second end.

14. The inflatable light device of claim 12, wherein the interchangeable decorative sleeve is composed of a fabric layer.

15. The inflatable light device of claim 12, wherein the interchangeable decorative sleeve is composed of a flexible polymer layer.

16. An inflatable light device, comprising:
an inflatable framework having a closed first end and an open second end;
a power source;
a rechargeable battery operatively connected to the power source;
a light assembly that includes a printed circuit board and at least one light emitting diode;
inlet/outlet architecture operatively connected to the inflatable framework to inflate and/or deflate the inflatable framework.

17. The inflatable light device of claim 16, wherein the power source comprises a solar power source having at least one solar panel operatively connected to the rechargeable battery.

18. The inflatable light device of claim 16, wherein the at least one solar panel is configured for placement on an outer face of the printed circuit board.

19. The inflatable light device of claim 17, further comprising:
a power switch configured for placement at an outer face of the printed circuit board; and
a reflector having at least one aperture configured for placement over the at least one light emitting diode.

20. The inflatable light device of claim 17, wherein:
the rechargeable battery is configured for placement at an inner face of the printed circuit board; and
the at least one light emitting diode is configured for placement at the inner face of the printed circuit board.
